(19) United States
(12) Patent Application Publication
(10) Pub. No.: US 2012/0222380 A1
(43) Pub. Date: Sep. 6, 2012

(54) Mount for connecting an article to a roof and method of use

(76) Inventors: Stuart H. Wentworth, Alamo, CA (US); Claudia H. Wentworth, Alamo, CA (US)

(21) Appl. No.: 12/932,672

(22) Filed: Mar. 3, 2011

(51) Int. Cl. E04B 1/38; F16L 3/00

(52) U.S. Cl. 52/698; 248/237; 248/49; 52/745.21

(57) ABSTRACT

A mount for connecting an article to a roof includes a flange which is connectable to the roof and a post which is received by the flange. In an embodiment, the post and flange cooperate with a bolt which holds the two together. In another embodiment, the post includes an elongated chamber through which an electrical wire can be routed.

### TECHNICAL FIELD

The present invention generally pertains to attaching articles to the roof of a structure, and more particularly to a mount which serves as an anchor for the articles.

### BACKGROUND OF THE INVENTION

On occasion it is necessary to attach articles to the roof of a structure. Such articles can include photovoltaic panels (solar panels), communication antennae, air conditioning equipment, heating equipment, and the like. The attachment is usually implemented by installing an anchor device on the roof, so that the article may be connected to the anchor device. The anchor device must necessarily penetrate the roof covering (such as a covering or shingles) and attach to a roof structural member such as a rafter. To minimize the possibility of water leaks, it is desirable to both minimize the number of roof penetrations and to ensure that the penetrations are water tight.

### BRIEF SUMMARY OF THE INVENTION

The present invention is directed to a mount for connecting an article to a roof. In one embodiment the mount cooperates with a bolt having a threaded portion and a head. The mount includes a flange which is connectable to the roof. The flange has a base having a first side and an opposite second side, the first side including a sleeve which defines a sleeve cavity, the opposite second side including a recess which is shaped and dimensioned to closely receive the head of the bolt, and the base having a through hole which is dimensioned to receive the threaded portion of the bolt. A post is shaped and dimensioned to be received by the sleeve cavity, the post having a first end and an opposite second end, the first end having a threaded hole which is dimensioned to threadably receive the threaded portion of the bolt. The bolt is positionable in the through hole of the flange so that the head of the bolt is received by the recess in the flange and the threaded portion of the bolt projects through the through hole and into the sleeve cavity. The post is insertable into the sleeve cavity so that the threaded hole can threadably engage the threaded portion of the bolt.

In another embodiment, the flange includes a plurality of buttresses which connect the first side of the base to the sleeve.

In another embodiment, the mount further cooperates with a sheet of flashing which has a frustoconical portion having a top hole and a conical angle. The buttresses have a buttress angle which is equal to the conical angle of the frustoconical portion, so that the flange is closely receivable by the frustoconical portion with the post outwardly projecting through the top hole.

In another embodiment, the post includes an elongated outer member which is spaced apart from an elongated inner core, a plurality of elongated vanes connect the elongated outer member to the elongated inner core, the elongated vanes defining a corresponding plurality of elongated chambers disposed within the post.

In another embodiment, the mount further cooperates with an electrical wire. The base has a wiring access hole disposed within the sleeve cavity. The electrical wire is passable through one of the plurality of elongated chambers and the wiring access hole.

In another embodiment, the second end of the post has a connection means for connecting the article to the post.

Other possible embodiments, in addition to the possible embodiments enumerated above, will become apparent from the following detailed description, taken in conjunction with the accompanying drawings, which illustrate, by way of example, the principles of the mount and method of use.

### BRIEF DESCRIPTION OF THE DRAWINGS

FIG. 1 is an exploded perspective view of a mount for connecting an article to a roof and a cooperating bolt;

FIG. 2 is a perspective view of the mount connected to a roof;

FIG. 3 is a perspective view of the mount connected to the roof, flashing installed over the mount, and article connected to the mount;

FIG. 4 is a top plan view of a flange;

FIG. 5 is a side elevation view of the flange;

FIG. 6 is a bottom plan view of the flange;

FIG. 7 is a cross sectional view along the line 7-7 of FIG. 4;

FIG. 8 is a top plan view of a post;

FIG. 9 is a side elevation view of the post;

FIG. 10 is a bottom plan view of the post;

FIG. 11 is a cross sectional view along the line 11-11 of FIG. 8;

FIG. 12 is a cross sectional view as in FIG. 7 showing the flange and a bolt;

FIG. 13 is a cross sectional view showing the post being connected to the flange and bolt;

FIG. 14 is a cross sectional view along the line 14-14 of FIG. 2;

FIG. 15 is a cross sectional view along the line 15-15 of FIG. 3.

FIG. 16 is a top plan view of a second embodiment flange; and,

FIG. 17 is a cross sectional view of the second embodiment flange, the post, and an electrical wire.

### DETAILED DESCRIPTION OF THE INVENTION

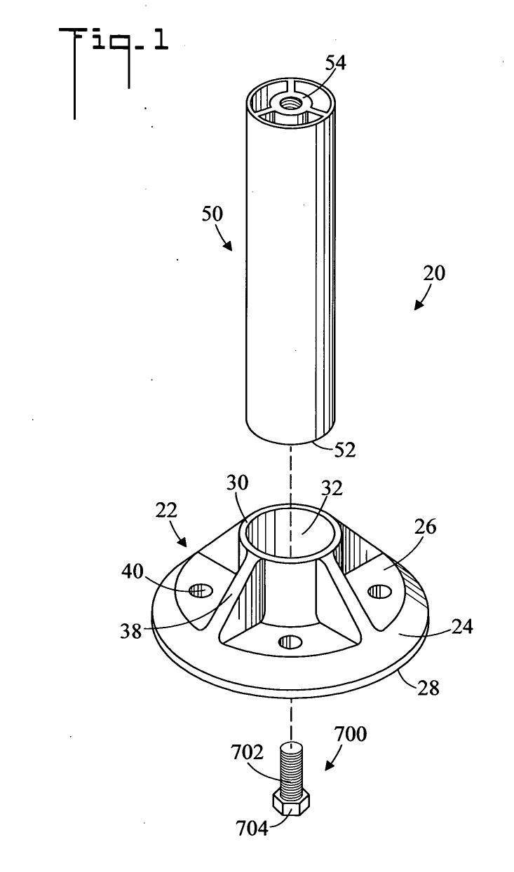

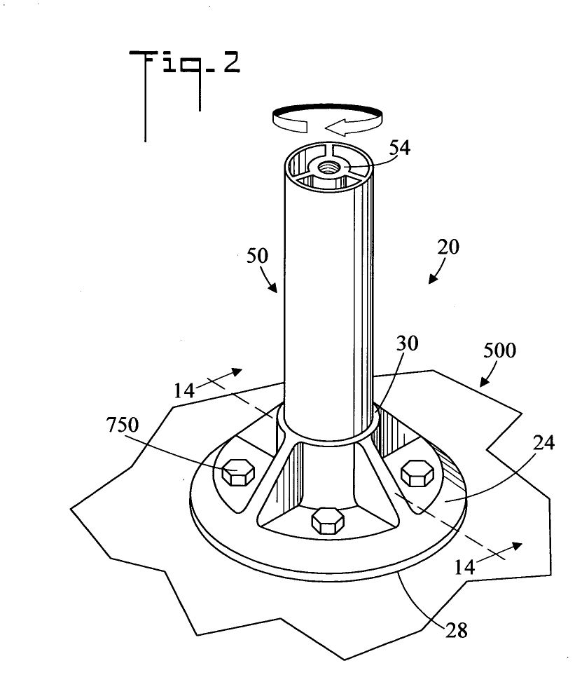

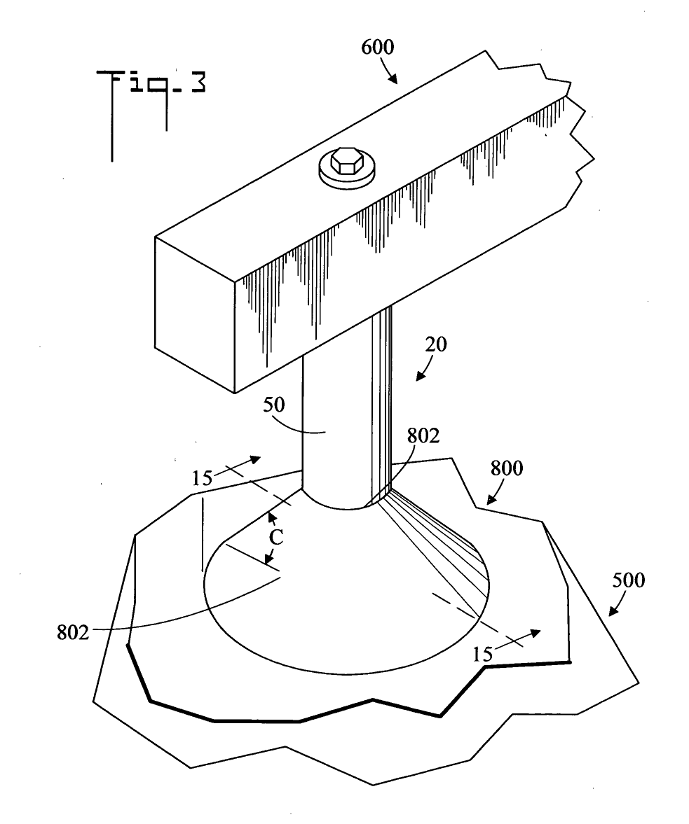

Referring initially to FIGS. 1 and 2, there are illustrated exploded perspective and perspective views respectively of a mount for connecting an article to a roof, the mount being designated as 20, the roof designated s 500, and the article designated as 600 (refer to FIG. 3). Mount 20 cooperates with a bolt 700 which has a threaded portion (shaft) 702 and a head 704. Mount 20 includes a flange 22 which is connectable to roof 500. Also referring to FIGS. 4-7, flange 22 has a base 24 which has a first side 26 and an opposite second side 28. First side 26 includes an upstanding sleeve 30 which defines a sleeve cavity 32. In the shown embodiment sleeve 30 is circular. Opposite second side 28 includes a recess 34 which is shaped and dimensioned to closely receive head 704 of bolt 700. The term “closely receive” means that when head 704 is inserted into recess 34, bolt 700 is prevented from rotating. Base 24 also includes a through hole 36 which is dimensioned to receive threaded portion 702 of bolt 700. In the shown embodiment recess 34 and through hole 36 are centered in flange 22. Flange 22 further includes a plurality of buttresses 38 (four in the shown embodiment) which connect first side 26 of base 24 to sleeve 30. Buttresses 38 provide structural support for sleeve 38 while reducing the weight of flange 22. Flange 22 further includes a plurality of mounting holes 40 which are used to connect flange 22 to roof 500 such as by screws 750 as shown in FIGS. 2 and 14.

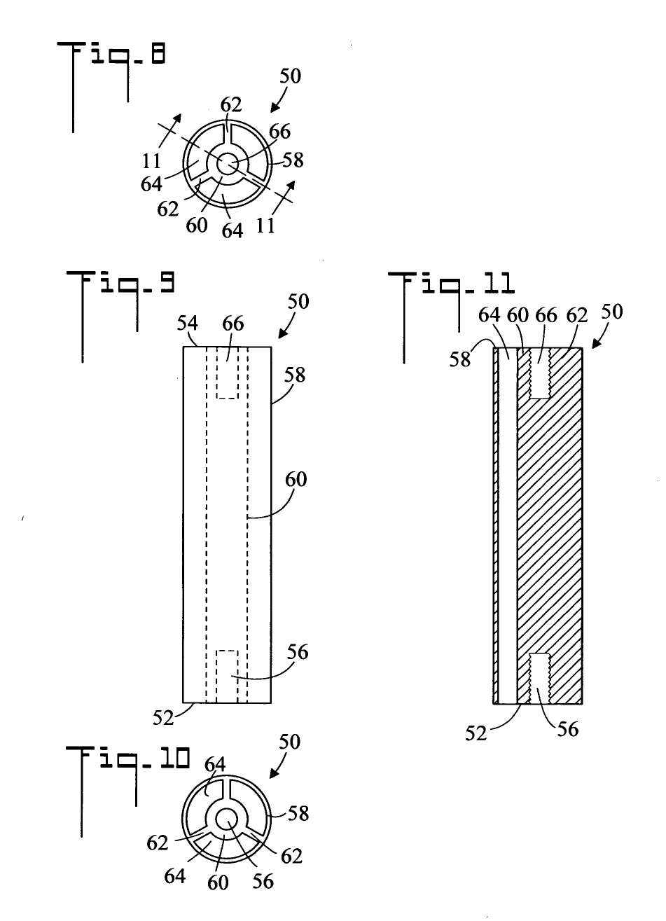

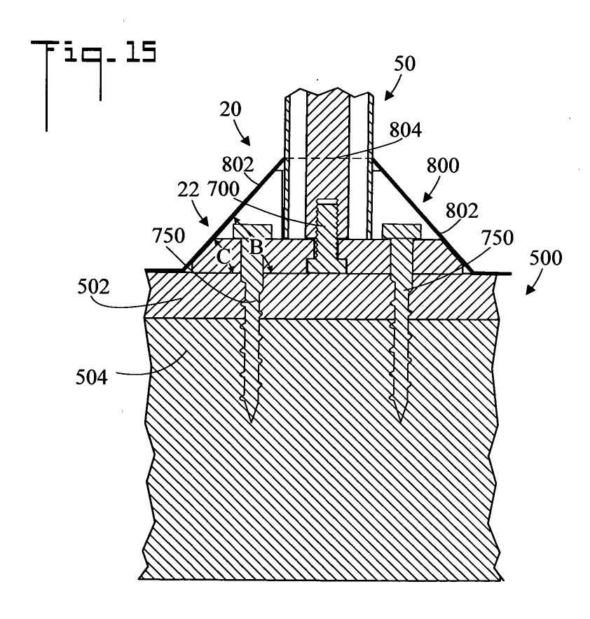

Also referring to FIGS. 8-11, mount 20 further includes a post 50 which is shaped and dimensioned to be received by sleeve cavity 32. In the shown embodiment, post 50 is circular to match circular sleeve 30 of flange 22. Post 50 has a first end 52 and an opposite second end 54. First end 52 has a threaded hole 56 which is dimensioned to threadably receive threaded portion 702 of bolt 700 (also refer to FIG. 10). In FIG. 2, post 50 has been positioned in sleeve cavity 32 so that threaded hole 56 threadably engages threaded portion 702 of bolt 700, and then post 50 has been rotated so that it tightens down onto bolt 700. In other words, bolt 700 holds flange 22 and post 50 together. It is noted that the tightening is possible because head 704 of bolt 700 is prevented from rotating by recess 34 (refer also to FIGS. 12-13 and the associated discussions).

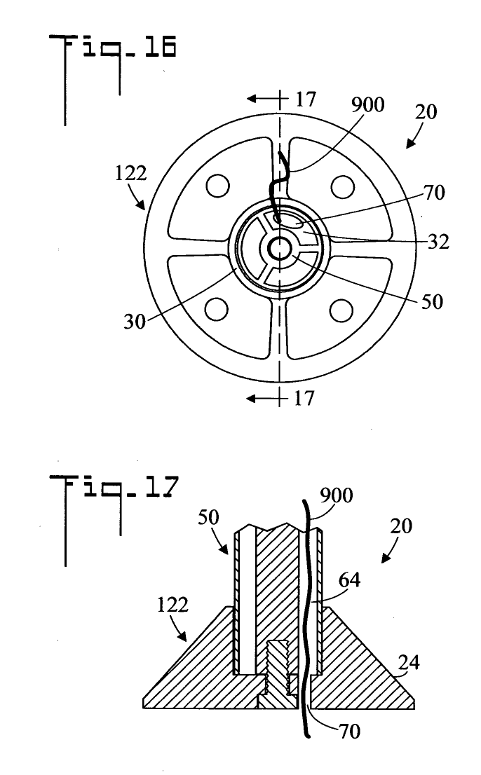

FIG. 3 is a perspective view of mount 20 connected to roof 500 (refer to FIG. 2), flashing 800 is installed over mount 20 and roof 500, and article 600 is connected to mount 20. In the shown embodiment, article 600 is a support member for a solar panel array. Flashing 800 is a sheet of metal which has a frustoconical portion 802 having a top hole 804 and a conical angle C (measured from base to side). Post 50 upwardly projects through frustoconical portion 802 of flashing 800 (also refer to FIG. 15). In the shown embodiment, article 600 is connected to the top end of post 50 with a bolt and washer.

FIG. 4-7 are top plan, side elevation, bottom plan, and cross sectional views respectively of flange 22. The depicted portions of flange 22 are, base 24, first (top) side 26, second (bottom) side 28, sleeve 30, sleeve cavity 32, recess 34, through hole 36, buttresses 38 and mounting holes 40. In FIG. 6, it is noted that recess 34 has a hexagonal shape to closely receive the hexagonal head of bolt 700 (refer to FIG. 1).

As previously discussed, mount 22 cooperates with sheet of flashing 800 which has a frustoconical portion 802, a top hole 804, and a conical angle C. Buttresses 38 have a buttress angle B (measured from base to side) which is equal to conical angle C of frustoconical portion 802, so that flange 22 is closely receivable by frustoconical portion 802 with post 50 outwardly projecting through top hole 804 (refer to FIGS. 3 and 15).

FIGS. 8-11 are top plan, side elevation, bottom plan, and cross sectional views respectively of post 50 showing first end 52, second end 54, and threaded hole 56. Post 50 includes an elongated outer member 58 (tube) which is spaced apart from an elongated inner core 60. A plurality (three in the shown embodiment) of elongated vanes 62 connect elongated outer member 58 to elongated inner core 60, and in so doing define a corresponding plurality of elongated internal chambers 64 (three in the shown embodiment) disposed within post 50. In other words, post 50 is not solid but rather comprises an inner core 60 which is connected to the outer member 58 by a plurality of vanes 62. As with flange 22, this design reduces the weight of post 50. Threaded hole 56 is disposed in the center of inner core 60.

Second end 54 of post 50 includes a connection means for connecting article 600 (refer to FIG. 3) to post 50. In the shown embodiment second end 54 of post 50 has a second threaded hole 66 for receiving article 600 via a bolt connection. It is noted however that the connection means could also be a threaded post, or any other structure which accommodates the mounting of article 600 to second end 54 of post 50. It is further noted that the material from which post 50 is made can be fabricated in long lengths (e.g. 15 feet), and transversely cut into shorter lengths for use as individual posts 50. After cutting, the ends of core member 60 would be threaded as appropriate.

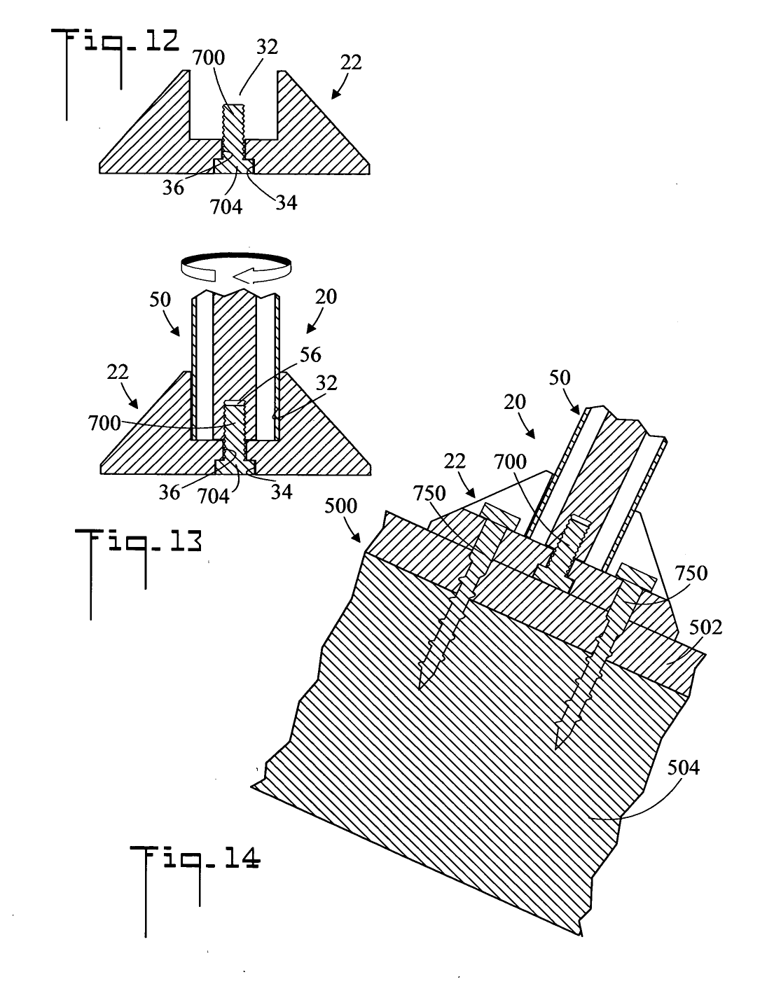

FIG. 11 shows cross sectional views of outer member 58, inner core 60, vane 62, cavity 64, and second threaded hole 66.

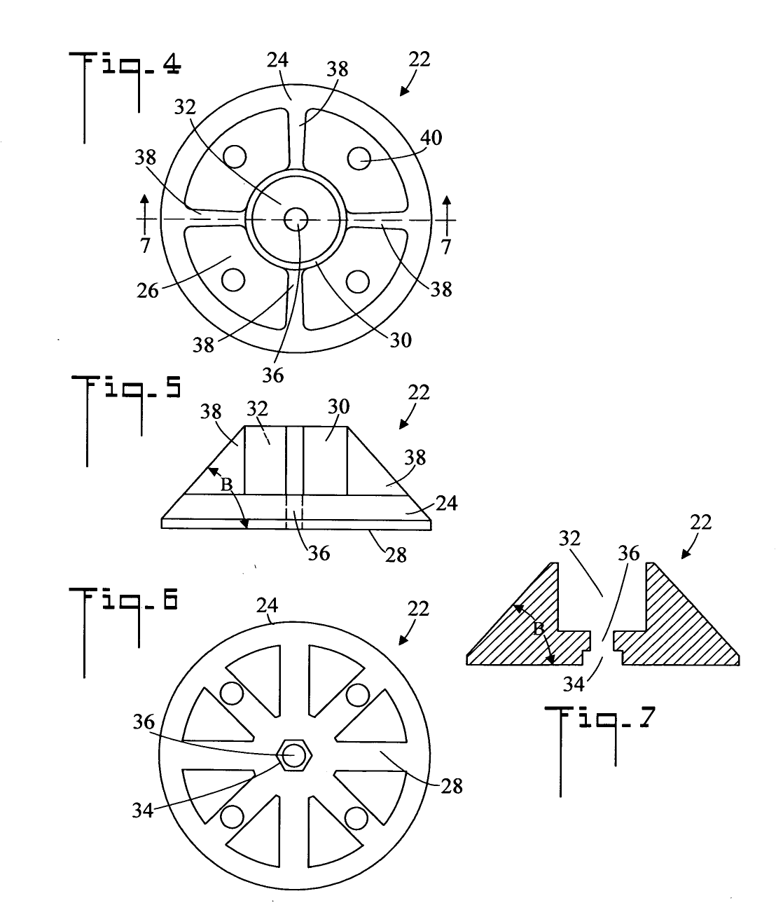

FIG. 12 is a cross sectional view as in FIG. 7 showing flange 22 and a bolt 700, and FIG. 13 is a cross sectional view showing post 500 being connected to flange 22 and bolt 700. Also referring to FIGS. 4-7, bolt 700 is positionable in through hole 36 of flange 22 so that head 704 of bolt 700 is received by recess 34 in flange 22 and threaded portion 702 of bolt 700 projects through through hole 36 and into sleeve cavity 32. Post 50 is then insertable into sleeve cavity 32 so that threaded hole 56 can threadably engage threaded portion 702 of bolt 700. Since recess 34 closely receives head 704 of bolt 700, bolt 700 cannot rotate as post 50 is threadably screwed onto it.

FIG. 14 is a cross sectional view along the line 14-14 of FIG. 2. Mount 20 including flange 22 and post 50, along with cooperating bolt 700 are positioned on roof 500. In the shown embodiment, roof 500 includes a covering 502 (such as plywood), which is connected to a structural member 504 (such as a rafter). Screws 750 are then used to connect flange 22 of mount 22 to the structural member 504 of roof 500. It is noted that either (1) flange 22 can be connected to roof 500 and then post 50 screwed into flange 22, or (2) post 50 can be screwed into flange 22 prior to connecting flange 22 to roof 500. In the shown embodiment mount 20 is connected to an angled roof 500, however mount 20 can also be connected to a flat roof 500 as is depicted in FIG. 15.

FIG. 15 is a cross sectional view along the line 15-15 of FIG. 3. After mount 20 is connected to roof 500 as in shown in FIG. 14, flashing 800 is placed over mount 22 as is shown in FIG. 3. Frustoconical portion 802 of flashing 800 closely receives mount 22 with post 50 upwardly projecting through top hole 804 in frustoconical portion 802. In practice additional roofing materials such as shingles or roofing paper are then applied over flashing 800 in the conventional manner. FIG. 15 also shows conical angle C of frustoconical portion 802 and equal buttress angle B.

FIG. 16 is a top plan view of a second embodiment flange 122, and FIG. 17 is a cross sectional view of the second embodiment flange 122. In this embodiment, mount 20 is cooperating with an electrical wire 900, wherein electrical wire 900 can be passed through mount 20. Used in conjunction with a hole in the roof, this embodiment provides a route for electrical wiring from above the roof to below the roof. In this embodiment base 24 of flange 22 has a wiring access hole 70 disposed within sleeve cavity 32. Electrical wire 900 is passable through one of the plurality of elongated chambers 60 in post 50 and wiring access hole 70. In another embodiment, wiring access hole can be a punch-out hole which is only opened if required.

In terms of use, a method for connecting an article 600 to a roof 500 includes: (refer to FIGS. 1-17)

(a) providing a roof 500 and an article 600 to be connected to roof 500;

(b) providing a bolt 700 having a threaded portion 702 and a head 704;

(c) providing a mount 20 for connecting article 600 to roof 500, including;
a flange 22 which is connectable to roof 500, flange 22 having a base 24 having a first side 26 and an opposite second side 28, first side 26 including a sleeve 30 which defines a sleeve cavity 32, opposite second side 28 including a recess 34 which is shaped and dimensioned to closely receive head 704 of bolt 700, and base 24 having a through hole 36 which is dimensioned to receive threaded portion 702 of bolt 700;
a post 50 which is shaped and dimensioned to be received by sleeve cavity 32, post 50 having a first end 52 and an opposite second end 54, first end 52 having a threaded hole 56 which is dimensioned to threadably receive threaded portion 702 of bolt 700;
bolt 700 positionable in through hole 36 of flange 22 so that head 704 of bolt 700 is received by recess 34 in flange 22 and threaded portion 702 of bolt 700 projects through through hole 36 and into sleeve cavity 32; and,
post 50 insertable into sleeve cavity 32 so that threaded hole 56 can threadably engage threaded portion 702 of bolt 700;

(d) positioning bolt 700 in through hole 36 so that head 704 of bolt 700 is received by recess 34 in flange 22 and threaded portion 702 of bolt 700 projects through through hole 36 into sleeve cavity 32;

(e) after step (d), connecting flange 22 to roof 500 with second side 28 of flange 22 abutting roof 500;

(f) inserting post 50 into sleeve cavity 32 so that threaded hole 56 threadably engages bolt 700; and,

(g) rotating post 50 to tighten it onto bolt 700 and flange 22.

The method further including:

providing a sheet of flashing 800 which has a frustoconical portion 802 having a top opening 804 and a conical angle C;

in step (c), flange 22 including a plurality of buttresses 38 which connect first side 26 of base 24 to sleeve 30;

in step (c), buttresses 38 having a buttress angle B which is equal to conical angle C of frustoconical portion 802, so that flange 22 is closely receivable by frustoconical portion 802; and,

positioning sheet of flashing 800 over flange 22 and post 50 so that flange 22 is closely received by frustoconical portion 802 and post 50 projects through top opening 804.

The method further including:

in step (c), second end 54 of post 50 having connection means for connecting article 600 to post 500; and,

after step (g), using the connection means to connect article 600 to post 50.

The method further including:

providing an electrical wire 900;

in step (c), post50 including an elongated outer member 58 which is spaced apart from an elongated inner core 60, a plurality of elongated vanes 62 connecting elongated outer member 58 to elongated inner core 60, vanes 62 defining a corresponding plurality of elongated chambers 64 disposed within post 50;

in step (c), base 24 having a wiring access hole 70 disposed within sleeve cavity 32; and,

passing electrical wire 900 through one of the plurality of elongated chambers 64 and wiring access hole 70.

The possible embodiments of the mount and method of use described herein are exemplary and numerous modifications, combinations, variations, and rearrangements can be readily envisioned to achieve an equivalent result, all of which are intended to be embraced within the scope of the appended claims. Further, nothing in the above-provided discussions of the mount and method of use should be construed as limiting the invention to a particular embodiment or combination of embodiments. The scope of the invention is best defined by the appended claims.

We claim:

1. A mount for connecting an article to a roof, the mount cooperating with a bolt having a threaded portion and a head, the mount comprising:
a flange which is connectable to the roof, said flange having a base having a first side and an opposite second side, said first side including a sleeve which defines a sleeve cavity, said opposite second side including a recess which is shaped and dimensioned to closely receive the head of the bolt, and said base having a through hole which is dimensioned to receive the threaded portion of the bolt;
a post which is shaped and dimensioned to be received by said sleeve cavity, said post having a first end and an opposite second end, said first end having a threaded hole which is dimensioned to threadably receive the threaded portion of the bolt;
the bolt positionable in said through hole of said flange so that the head of the bolt is received by said recess in said flange and the threaded portion of the bolt projects through said through hole and into said sleeve cavity; and,
said post insertable into said sleeve cavity so that said threaded hole can threadably engage the threaded portion of the bolt.

2. The mount according to claim 1, further including:
said flange including a plurality of buttresses which connect said first side of said base to said sleeve.

3. The mount according to claim 2, the mount cooperating with a sheet of flashing which has a frustoconical portion having a top hole and a conical angle, the mount further including:
said buttresses having a buttress angle which is equal to the conical angle of the frustoconical portion, so that said flange is closely receivable by the frustoconical portion with said post outwardly projecting through the top hole.

4. The mount according to claim 1, further including:
said post including an elongated outer member which is spaced apart from an elongated inner core, a plurality of elongated vanes connecting said elongated outer member to said elongated inner core, said elongated vanes defining a corresponding plurality of elongated chambers disposed within said post.

5. The mount according to claim 4, the mount cooperating with an electrical wire, the mount further including:
said base having a wiring access hole disposed within said sleeve cavity; and,
the electrical wire passable through one of said plurality of elongated chambers and said wiring access hole.

6. The mount according to claim 1, further including:
said second end of said post having connection means for connecting the article to said post.

7. The mount according to claim 1, the mount cooperating with a sheet of flashing which has a frustoconical portion having a top hole and a conical angle, and with an electrical wire, the mount further including:
said flange including a plurality of buttresses which connect said first side of said base to said sleeve;
said buttresses having a buttress angle which is equal to the conical angle of the frustoconical portion, so that said flange is closely receivable by the frustoconical portion with said post outwardly projecting through the top hole;
said post including an elongated outside member and an elongated inner core, a plurality of elongated vanes connecting said elongated outside member to said elongated inner core, said elongated vanes defining a corresponding plurality of elongated chambers disposed within said post;
said base having a wiring access hole disposed within said sleeve cavity;
the electrical wire passable through one of said plurality of elongated chambers and said wiring access hole; and,
said second end of said post having connection means for connecting the article to said post.

8. A mount for connecting an article to a roof, comprising,
a flange which is connectable to the roof, said flange having a base having a first side and an opposite second side, said first side including a sleeve which defines a sleeve cavity;
a post which is shaped and dimensioned to be received by said sleeve cavity; and,
said post including an elongated outside member and an elongated inner core, a plurality of elongated vanes connecting said elongated outside member to said elongated inner core, said vanes defining a corresponding plurality of elongated chambers disposed within said post.

9. The mount according to claim 8, the mount cooperating with an electrical wire, the mount further including:
said base having a wiring access hole disposed within said sleeve cavity; and,
the electrical wire passable through one of said plurality of elongated chambers and said wiring access hole.

10. A method for connecting an article to a roof, comprising:
(a) providing a roof and an article to be connected to said roof;
(b) providing a bolt having a threaded portion and a head;
(c) providing a mount for connecting said article to said roof, including;
a flange which is connectable to said roof, said flange having a base having a first side and an opposite second side, said first side including a sleeve which defines a sleeve cavity, said opposite second side including a recess which is shaped and dimensioned to closely receive said head of said bolt, and said base having a through hole which is dimensioned to receive said threaded portion of said bolt;
a post which is shaped and dimensioned to be received by said sleeve cavity, said post having a first end and an opposite second end, said first end having a threaded hole which is dimensioned to threadably receive said threaded portion of said bolt;
the bolt positionable in said through hole of said flange so that said head of said bolt is received by said recess in said flange and said threaded portion of said bolt projects through said through hole into said sleeve cavity; and,
said post insertable into said sleeve cavity so that said threaded hole can threadably engage said threaded portion of said bolt;
(d) positioning said bolt in said through hole so that said head of said bolt is received by said recess in said flange and said threaded portion of said bolt projects through said through hole into said sleeve cavity;
(e) after step (d), connecting said flange to said roof with said second side of said flange abutting said roof;
(f) inserting said post into said sleeve cavity so that said threaded hole threadably engages said bolt; and,
(g) rotating said post to tighten it onto said bolt.

11. The method of claim 10, further including:
providing a sheet of flashing which has a frustoconical portion having a top opening and a conical angle;
in step (c), said flange including a plurality of buttresses which connect said first side of said base to said sleeve;
in step (c), said buttresses having a buttress angle which is equal to said conical angle of said frustoconical portion, so that said flange is closely receivable by said frustoconical portion; and,
positioning said sheet of flashing over said flange and said post so that said flange is closely received by said frustoconical portion and said post projects through said top opening.

12. The method of claim 10, further including:
in step (c), said second end of said post having connection means for connecting said article to said post; and,
after step (g), using said connection means to connect said article to said post.

13. The method of claim 10, further including:
providing an electrical wire;
in step (c), said post including an elongated outer member which is spaced apart from an elongated inner core, a plurality of elongated vanes connecting said elongated outer member to said elongated inner core, said vanes defining a corresponding plurality of elongated chambers disposed within said post;
in step (c), said base having a wiring access hole disposed within said sleeve cavity; and,
passing said electrical wire through one of said plurality of elongated chambers and said wiring access hole.
